(19) United States
(12) Patent Application Publication
(10) Pub. No.: US 2023/0370438 A1
(43) Pub. Date: Nov. 16, 2023

(54) METHOD FOR TRANSMITTING DATA

(71) Applicant: PENGUINCODE KG, Wien (AT)

(72) Inventor: Sebastian MAYER, Wien (AT)

(21) Appl. No.: 18/245,333

(22) PCT Filed: Sep. 13, 2021
(86) PCT No.: PCT/AT2021/060323

§ 371 Date: Mar. 14, 2023

(30) Foreign Application Priority Data
Sep. 14, 2020 (AT) A 50777/2020

(51) Int. Cl. H04L 9/40

(52) U.S. Cl. CPC H04L 63/0428

(57) ABSTRACT

The invention relates to a method for transmitting data by: - providing the data to be transmitted; - providing random data, the quantity of which is at least as large as the quantity of the data to be transmitted; - encrypting the data to be transmitted using the random data in order to obtain encrypted data; - transmitting the encrypted data to at least one receiver; - transmitting the random data to the at least one receiver; - receiving the encrypted data and the random data by the at least one receiver; - decrypting the received encrypted data using the received random data by the at least one receiver; - transmitting the encrypted data to the at least one receiver via a first data communication service; and - transmitting the random data to the at least one receiver via a second data communication service which differs from the first data communication service.

The invention relates to a method for transmitting data by:
providing the data to be transmitted;
providing random data, the quantity of which is at least as large as the quantity of the data to be transmitted;
encrypting the data to be transmitted using the random data in order to obtain encrypted data;
transmitting the encrypted data to at least one receiver;
transmitting the random data to the at least one receiver;
receiving the encrypted data and the random data by the at least one receiver; and
decrypting the received encrypted data using the received random data by the at least one receiver.

As is known, data to be transmitted can be encrypted with random data and subsequently transmitted from a transmitter to at least one receiver. By encrypting the data to be transmitted with random data, the former are effectively protected against unauthorised access, depending on the quality of the encryption. The encrypted data transmitted can be decrypted again by the user who knows the key used for encryption.

A known encryption method is OTP (One-Time-Pad), which is a symmetrical method for secret data transmission. In this connection, the key is at least as long as the message to be encrypted. Because the key has random content and is only used once for encryption, the encrypted message cannot be decrypted without knowing the key. Therefore, the key is sent to the receiver of the message.

U.S. Pat. No. 6,064,738 A relates to a method for encrypting and decrypting larger quantities of data, such as, for example, images. In this connection, an image is used as a mask (OTP) in order to encrypt a different image of the same size for this purpose.

WO 2015/157720 A2 discloses a use of various transmission methods, such as SMS, iMessage, e-mail, for encrypted text messages.

US 2015/0295907 A1 relates to the encryption and decryption of content using OTP techniques, wherein, for example, an image selected by a user serves as a source for a key.

Critical in encryption procedures is that an attacker who wants to decrypt the encrypted message could try to gain access to the key. Known transmission methods do not offer sufficient protection against spying out keys used for OTP encryption of the transmitted messages.

It is an object of the invention to provide a method as indicated at the beginning, which avoids or at least reduces the disadvantages of the prior art. In particular, the key which is used for the encryption of a message to be transmitted and for the decryption of the transmitted message is to be transmitted in such a way that it is protected as well as possible from being spied on. In addition, the method should be executable with little expenditure of time and money for a user.

This object is achieved by a method according to claim 1. Advantageous embodiments and further developments are specified in the dependent claims.

The invention is characterised by
transmitting the encrypted data to the at least one receiver via a first data communication service; and
transmitting the random data to the at least one receiver via a second data communication service which differs from the first data communication service.

The method is thus useful for transmitting data from a transmitter to at least one receiver. In this context, a transmitter and a receiver can be understood to mean both a person and a user device, for example a computer or a mobile telephone or smartphone, or generally a device with suitable hardware and software components. According to the method, the data to be transmitted and the random data are first provided, for example, by a user of the method or by a software application. The data to be transmitted, which will also be referred to below as payload, can comprise any information, for example text messages, audio or video contents. The random data is characterised by a content that cannot be predicted by an attacker, even if parts of the random data are already known. The random data can be generated by a random generator. In order to protect the data to be transmitted from unwanted reading by persons or institutions who shall not be involved in the exchange of messages, i.e. from attackers, the data to be transmitted are encrypted with the random data before transmission, resulting in encrypted data. The random data thus represents a key used for encryption. For example, the encryption of the payload with the random data takes place via an Exclusive-OR link (XOR). The encryption is preferably an OTP encryption. In this context, the quantity of random data, i.e. the number of bytes of the random data, is equal to or greater than the quantity of the data to be transmitted. The encryption takes place, for example, in the user device of the sending person or generally in a digital processing unit. The encrypted data and the random data are then transmitted from the sender to a receiver or to a group of receivers. The transmission can be wired or wireless. The at least one receiver receives the encrypted data and the random data and decrypts the received encrypted data using the received random data in order to thereby obtain the payload transmitted by the transmitter. The transmission of the encrypted data to the at least one receiver is made via a first data communication service, for example via e-mail. In order to make it as difficult as possible or impossible for an attacker to recognise the random data, i.e. the key, also transmitted to the at least one receiver, the random data is transmitted to the at least one receiver via a second data communication service, which differs from the first data communication service. Preferably, the second data communication service is a service frequently used for message exchange among two or more subscribers, for example WhatsApp of Facebook Inc. In this way, the payload can be kept secret, since it is encrypted with random data and cannot be decrypted without knowledge of the key. In addition, the key itself can be detected with very low or no probability by persons or institutions who are not supposed to be involved in the communication. It is essential in this connection that the key is transmitted via the second data communication service, which differs from the first data communication service. An attacker would therefore have to monitor all conceivable data communication services in order to discover a message containing the key. The key itself is preferably part of a message sent via the second data communication service, which message preferably also contains text, and thus cannot be recognised as a key by an attacker. Thus, the key (i.e. the random data) is part of the digital everyday communication and is therefore hidden in the mass of data of the message exchange among two or more persons.

According to a preferred embodiment of the invention, a digital representation of the content of at least one of an image file, a video file, an audio file or a file with measured values is used as random data. In this context, a digital representation can be understood to mean a bit sequence. The image file, video file, audio file or file with measured values can be recorded by the user or in general by the sender before encryption with the payload, for example with a camera, a microphone or a sensor, and particularly preferably contains an arbitrary, in particular non-reproducible, content. For example, an image, an audio signal or a video of a road traffic situation can be recorded with a smartphone. If the content of such an image, audio signal or video is unpredictable, the digital representation also contains random data. Alternatively, the digital representation of the content of at least one of an image file, video file, audio file or file with measured values, which are known per se, can also be used as random data. Even in this case, the digital representation represents random data if the content of the known image file, video file, audio file or file with measured values is not known to an attacker. Of course, a combination of an image file, a video file, an audio file or a file with measured values can be used as random data.

Particularly preferably, a digital representation of at least part of the content of a website can be used as random data. The website can be called up and stored by the user or generally by the sender prior to encryption with the payload in order to use the digital representation, in particular the bit sequence thereof, as random data. It is particularly favourable if the website represents a video recording, for example real-time recordings of a camera. The user can thus access existing random data and save themselves the trouble of recording it. In particular, the user does not need any device for recording an image, video, tone or other signal.

When a digital representation of a randomly selected part of a website content is used as random data, the origin of the random data is even more difficult or even impossible for an attacker to trace. In addition, the quantity of data to be transmitted, i.e. the size of the key, can thereby be reduced in comparison to the transmission of the entire website as a key. In particular, the randomly selected part of the website alone cannot make sense to an observer or attacker.

Preferably, at least the part of the content of a website or the randomly selected part of the content of a website can be selected by a user or by a processing unit, i.e. also by a computer program.

In order to further complicate spying on a key belonging to an encrypted sent message, a time interval can be inserted between the transmission of the encrypted data and the transmission of the random data. Thus, an attacker cannot trust that the random data, as a key, will be transmitted at about the same time as the encrypted data. The time interval can have the value zero in order to allow simultaneous transmission if necessary. The time interval can be defined in advance. Preferably, the time interval may have a value in the range of 0 seconds to 3 days. However, the time interval can also have a value range with a smallest value and a largest value, wherein the time gap between the transmission of the encrypted data and the transmission of the random data then lies within this value range. In this way, the transmission of the encrypted data can be spaced apart in time from the transmission of the random data without delaying the decryption beyond a specific time limit. Preferably, the encrypted data can be transmitted in case of a time interval not equal to zero before or after the random data.

For a successful decryption of the received encrypted data it can be provided that the received encrypted data is assigned to the received random data when a previously defined criterion is met. In this case, the received encrypted data are assigned to the received random data, i.e. the key, via the predefined criterion. The predefined criterion is known to the sender and the receiver of the encrypted data, but not to an attacker. The receiver is thus able to recognise the random data using the criterion known to the receiver and to use the random data for decryption, i.e. to apply it to the encrypted data received. On the other hand, the attacker is not able to select exactly the data containing the key from a large number of data transmissions between the sender and the receiver. In the event of an attempt to decrypt the encrypted data with incorrectly selected random data, the attacker cannot always determine with certainty whether the decryption has delivered the payload sent, for example, in the case of measurement results or random-looking information.

Preferably, the assignment of the received encrypted data to the received random data can be performed by respecting a time interval between the receipt of the encrypted data and the receipt of the random data and/or by recognising a content of at least one of an image file, a video file, an audio file or a file with measured values, of which image file, video file, audio file or file with measured values a digital representation is used as the random data, as a predefined criterion. If the predefined time interval is used as a criterion, this is known to both the sender and the receiver and the sender ensures timely transmission of the encrypted data and the random data. Thus, the received random data can be assigned to the received encrypted data by the receiver for decryption via the temporal context of the reception. Alternatively or additionally, the recognition of a content of at least one of an image file, a video file, an audio file or a file with measured values can be used as a predefined criterion, wherein a digital representation of the image file, video file, audio file or file with measured values forms the random data. The recognition of a content can comprise, for example, a recognition of a predefined pattern or object in the image or video of the image or video file, a sound or a tone sequence in the audio file or specific values in the measurement data. For example, it can be agreed as a criterion that a certain number of people must be recognisable in the image. Thus, even via the predefined content of the received image, video, tone or measurement values, the received random data can be assigned to the received encrypted data by the receiver for decryption.

According to another preferred embodiment, the triggering of the transmission of the encrypted data can take place by triggering the transmission of the random data or vice versa. In this way, triggering the transmission of the encrypted data causes automatic triggering of the transmission of the random data, or triggering the transmission of the random data causes automatic triggering of the transmission of the encrypted data. The automatic triggering can be carried out by the user device, in particular a processing unit. This saves the user the trouble of having to transmit himself, i.e. manually, the encrypted data via the first data communication service and the random data via the second data communication service. Instead, it can be provided that the user actuates a button on the user device, whereupon the encrypted data and the random data are transmitted by the user device or the processing unit.

For the following description of a system for executing the method described above, reference is also made to the previous description of the method, insofar as this is applicable to the system.

A system for transmitting data with a first user device or a sending person as a sender and at least one second user device or at least one receiving person as a receiver is provided for carrying out the method. The first user device is designed to provide the data to be transmitted and the random data, wherein the quantity of the random data is at least equal to the quantity of the data to be transmitted, to encrypt the data to be transmitted with the random data in order to obtain encrypted data, and to transmit the encrypted data and the random data to the second user device. The second user device is designed to receive the encrypted data and the random data and to decrypt the received encrypted data using the received random data. In this context, the first user device is designed to transmit the encrypted data via a first data communication service to the second user device and to transmit the random data via a second data communication service, which differs from the first data communication service, to the second user device.

The first user device may be configured to use a digital representation of the content of at least one of an image file, a video file, an audio file or a file with measured values as random data.

The first user device may also be configured to use a digital representation of at least part of the content of a website as random data.

The first user device may also be configured to use a digital representation of a randomly selected part of the content of a website as random data.

Furthermore, the first user device may be configured to insert a time interval between the transmission of the encrypted data and the transmission of the random data.

The second user device may be configured to assign the received encrypted data to the received random data when a predefined criterion is met.

The second user device may also be configured to comprise as a predefined criterion respecting a time interval between the receipt of the encrypted data and the receipt of the random data and/or recognising a content of at least one of an image file, a video file, an audio file or a file with measured values, of which image file, video file, audio file or file with measured values a digital representation is used as the random data.

Furthermore, the first user device may be configured to trigger the transmission of the encrypted data by triggering the transmission of the random data or vice versa.

The invention will be explained in more detail below with reference to preferred exemplary embodiments, to which, however, it is not intended to be limited. In the single drawing:

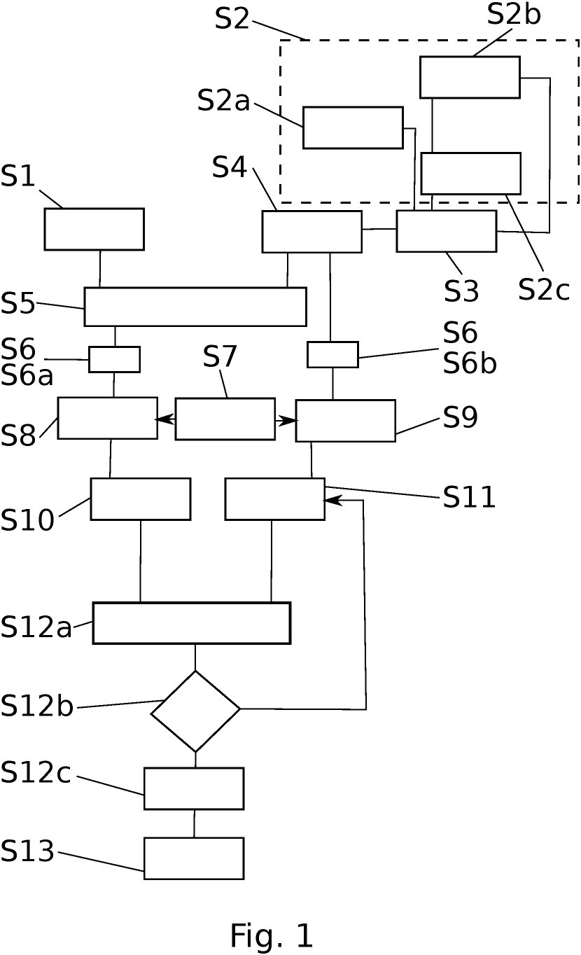

FIG. 1 shows a flow chart of the method for transmitting data according to the invention.

In Step S1, the data to be transmitted, i.e. payload, are provided by a user or a processing unit, for example a computer program.

In Step S2a, at least one of an image file, a video file, an audio file or a file with measured values can be provided by the user or the processing unit, for example a computer program. In an alternative or additional Step S2b to step S2a, at least a part of the content of a website can be provided by the user or the processing unit, for example a computer program. In an optional Step S2c, a part of the content of the website provided in step S2b can be randomly selected by the user or the processing unit, for example a computer program. Steps S2a, S2b and S2c together make Step S2. Thus, in Step S2, an image, a video, an audio signal or measured values are provided, which are provided in order to capture a digital representation thereof.

In step S3, the digital representation of the image file, video file, audio file or file with measured values provided in Step S2a, or a digital representation of the website provided in Step S2b or of the part thereof, or a digital representation of the randomly selected part of the website provided in Step S2c is captured. For example, the digital representation is stored as a bit sequence at a predetermined memory location.

In Step S4, the digital representation from step S3 is defined and provided as random data for use for encrypting the data to be transmitted from Step S1. In this connection in step S4, the user or the processing unit, for example a computer program, can also check whether the quantity of random data is at least as large as the quantity of data to be transmitted. If this is not the case, an error message may be output to the user.

In Step S5, the data to be transmitted from step S1 is encrypted with the random data from Step S4 in order to obtain encrypted data.

In Step S6, the user or the processing unit, for example a computer program, can specify a time interval that is to be inserted between the transmission of the encrypted data and the transmission of the random data. The time interval is symbolically represented by the blocks S6a and S6b, each of which is intended to indicate a possible time delay and thus jointly a possible time difference between the transmission of the encrypted data and the transmission of the random data.

In Step S7, the user or the processing unit, for example a computer program, can determine whether the transmission of the encrypted data is to be triggered by triggering the transmission of the random data or vice versa. If this is not desired, the transmission of the encrypted data and the transmission of the random data are triggered manually by the user.

In Step S8, the transmission of the encrypted data to the at least one receiver is made via a first data communication service.

In Step S9 the transmission of the random data to the at least one receiver is made via a second data communication service which differs from the first data communication service.

Depending on the possible time interval in Step S6, between the transmission of the encrypted data and the transmission of the random data, Step S8 can be carried out before or after Step S9.

In Step S10, the encrypted data is received by the at least one receiver.

In Step S11, the random data are received by the at least one receiver.

In Step S12a, it can be checked whether a predefined criterion and which predefined criterion should be fulfilled as a prerequisite for assigning the received encrypted data to the received random data. The predefined criterion may be defined as respecting a time interval between the receipt of the encrypted data and the receipt of the random data and/or recognising a content of at least one of an image file, a video file, an audio file or a file with measured values, of which image file, video file, audio file or file with measured values a digital representation is used as the random data. Thus, in Step S12a, a time interval between the receipt of the encrypted data and the receipt of the random data can be compared with a setpoint value by the user or the processing unit, for example a computer program. Additionally or alternatively, the content of at least one of an image file, a video file, an audio file or a file with measured values can be compared with a target content by the user or the processing unit, for example a computer program.

In Step S12b, it is possible to check, on the basis of the comparison carried out in step S12a, whether the predefined criterion for assigning the received encrypted data to the received random data is fulfilled. If yes, the received encrypted data are assigned to the received random data in Step S12c. If no, the method returns to Step S11, in which the reception of new random data is awaited.

In Step S13, the received encrypted data is decrypted by means of the at least one receiver using the received random data.

1. A method for transmitting data by:
providing the data to be transmitted;
providing random data, the quantity of which is at least as large as the quantity of the data to be transmitted;
encrypting the data to be transmitted using the random data in order to obtain encrypted data;
transmitting the encrypted data to at least one receiver;
transmitting the random data to the at least one receiver;
receiving the encrypted data and the random data by the at least one receiver;
decrypting the received encrypted data using the received random data by the at least one receiver; comprising
transmitting the encrypted data to the at least one receiver via a first data communication service; and
transmitting the random data to the at least one receiver via a second data communication service which differs from the first data communication service.

2. The method according to claim 1, comprising using a digital representation of the content of at least one of an image file, a video file, an audio file or a file with measured values as random data.

3. The method according to claim 2, comprising using a digital representation of at least a part of the content of a website as random data.

4. The method according to claim 3, comprising using a digital representation of a randomly selected part of the content of a website as random data.

5. The method according to claim 1, comprising inserting a time interval between the transmission of the encrypted data and the transmission of the random data.

6. The method according to claim 1, comprising assigning the received encrypted data to the received random data when a predefined criterion is met.

7. The method according to claim 6, comprising respecting a time interval between the receipt of the encrypted data and the receipt of the random data as a predefined criterion and/or recognising a content of at least one of an image file, a video file, an audio file or a file with measured values as a predefined criterion, of which image file, video file, audio file or file with measured values a digital representation is used as the random data.

8. The method according to claim 5, comprising triggering the transmission of the encrypted data by triggering the transmission of the random data or vice versa.
